(19) United States
(12) Patent Application Publication
(10) Pub. No.: US 2026/0223262 A1
(43) Pub. Date: Jul. 30, 2026

(54) Backlight Data Mapping Circuit, Display Control Device and Backlight Control Data Mapping Method

(71) Applicant: NOVATEK Microelectronics Corp., Hsinchu (TW)

(72) Inventors: Shu-Wei Chang, Tainan City (TW); Chien-Hsing Shen, Tainan City (TW)

(73) Assignee: NOVATEK Microelectronics Corp., Hsinchu (TW)

(21) Appl. No.: 19/457,168

(22) Filed: Jan. 23, 2026

Related U.S. Application Data
(60) Provisional application No. 63/749,001, filed on Jan. 24, 2025.

(51) Int. Cl. H05B 45/10; H05B 45/325

(52) U.S. Cl. CPC H05B 45/10; H05B 45/325

(57) ABSTRACT

A backlight data mapping circuit is provided. The backlight data mapping circuit includes a memory control circuit, a mapping control circuit and an arrangement circuit. The memory control circuit is configured to sequentially write original duty cycle information corresponding to a plurality of backlight zones of a backlight panel into a first memory unit. The mapping control circuit is configured to convert the original duty cycle information into mapped duty cycle information according to a remapping table and store the mapped duty cycle information into a second memory unit. The remapping table comprises a plurality of location index numbers that indicate respective locations of the first memory unit or the second memory unit. The arrangement circuit is configured to convert the mapped duty cycle information into rearranged duty cycle information matching a backlight driver output format according to backlight-zone-to-driver-output mapping information that defines a plurality of status values.

### CROSS REFERENCE TO RELATED APPLICATIONS

This application claims the benefit of U.S. Provisional Application No. 63/749,001, filed on January 24th, 2025. The content of the application is incorporated herein by reference.

### BACKGROUND OF THE INVENTION

### 1. FIELD OF THE INVENTION

The present invention relates to a backlight data mapping circuit, a display control device and a backlight control data mapping method, and more particularly, to a backlight data mapping circuit, a display control device and a backlight control data mapping method capable of fast mapping backlight data in a proper arrangement for driving backlight zone of backlight panel.

### 2. DESCRIPTION OF THE PRIOR ART

A backlight module equipped with a light-emitting diode (LED) array is usually used in a display device to provide light source for a display panel, such as a thin-film transistor liquid-crystal display (TFT-LCD) panel). To improve visual effects, a local dimming method may be applied in the display device. Please refer to FIG. 1. FIG. 1 is a schematic diagram illustrating backlight drivers 102_1 to 102_n and a backlight panel 104 of a backlight module. As shown in FIG. 1, the backlight panel 104 can be divided into multiple backlight zones, wherein each backlight zone (as a grid in FIG. 1) includes a series of LEDs or an array of LEDs. The driving current of each backlight zone can be controlled individually. Further, the LED driving current can be controlled by using a pulse width modulation (PWM) signal. The duty cycle of the PWM signal corresponding to each backlight zone can be stored in a register. The firmware can control a microcontroller unit (MCU) (e.g., microcontroller unit 100 shown in FIG. 1) to read out the stored duty cycle information and write the duty cycle information to a configured storage unit. The microcontroller unit 100 then reads the duty cycle information from the configured storage unit and transmits the duty cycle information to the backlight drivers 102_1 to 102_n for performing local dimming control. However, as the number of backlight zones increases, the firmware has to spend a lot of time on reading and writing the duty cycle information for controlling the microcontroller unit, and thus the efficiency of local dimming control is significantly reduced. Thus, there is a need for improvement.

### SUMMARY OF THE INVENTION

It is therefore an objective of the present invention to provide a backlight data mapping circuit, a display control device and a backlight control data mapping method capable of fast mapping backlight data in a proper arrangement for driving backlight zone of backlight panel, to solve the abovementioned problem.

An embodiment of the present invention discloses a backlight data mapping circuit, comprising: a memory control circuit, configured to sequentially write original duty cycle information corresponding to a plurality of backlight zones of a backlight panel into a first memory unit; a mapping control circuit, configured to convert the original duty cycle information into mapped duty cycle information according to a remapping table and store the mapped duty cycle information into a second memory unit, wherein the remapping table comprises a plurality of location index numbers that indicate respective locations of the first memory unit or the second memory unit; and an arrangement circuit, configured to convert the mapped duty cycle information into rearranged duty cycle information matching a backlight driver output format according to backlight-zone-to-driver-output mapping information that defines a plurality of status values, each status value being with respect to each driving channel of a plurality of LED driver who drive the backlight zones of the backlight panel.

An embodiment of the present invention discloses a display control device for driving a backlight panel, the backlight panel comprising a plurality of backlight zones, the display control device comprising: a first memory unit; a second memory unit; a local dimming control circuit, configured to generate original duty cycle information corresponding to the plurality of backlight zones; a backlight data mapping circuit, configured to receive the original duty cycle information corresponding to the plurality of backlight zones and generate rearranged duty cycle information corresponding to the plurality of backlight zones; a third memory unit, configured to store the rearranged duty cycle information; and a microcontroller unit, configured to control the rearranged duty cycle information stored in the third memory unit to be transmitted to at least one backlight driver.

An embodiment of the present invention discloses a backlight control data mapping method, comprising: sequentially writing original duty cycle information corresponding to a plurality of backlight zone of a backlight panel into a first memory unit; converting the original duty cycle information into mapped duty cycle information according to a remapping table and storing the mapped duty cycle information into a second memory unit, wherein the remapping table comprises a plurality of location index numbers that indicate respective locations of the first memory unit or the second memory unit; and converting the mapped duty cycle information into rearranged duty cycle information matching a driver output format according to backlight-zone-to-driver-output mapping information that defines a plurality of status values, each status value being with respect to each driving channel of a plurality of LED driver who drive the backlight zones of the backlight panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating backlight drivers integrated circuits and backlight panel.

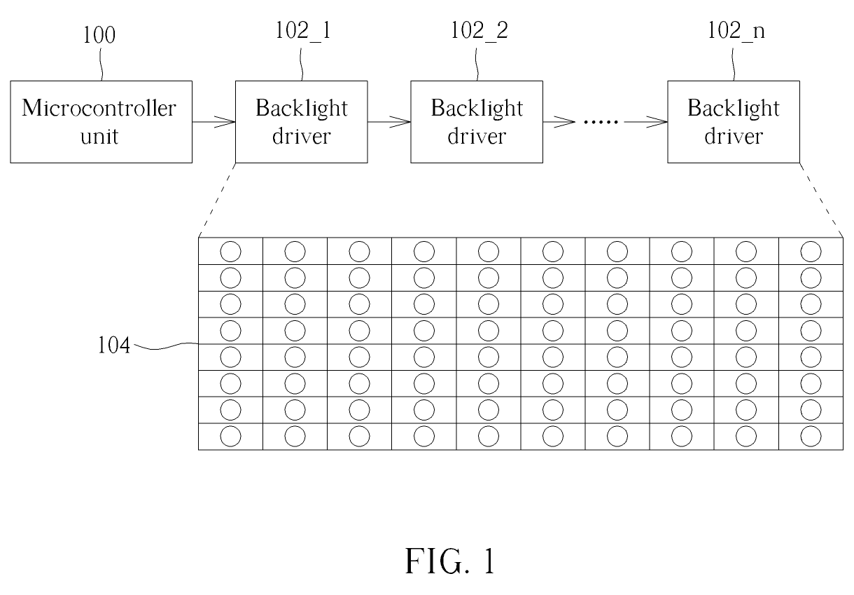

FIG. 2 is a schematic diagram of a display system according to an embodiment of the present invention.

FIG. 3 is a schematic diagram of a display system according to an alternative embodiment of the present invention.

FIG. 4 is a schematic diagram of a display control device of the display system according to an embodiment of the present invention.

FIG. 5 is a flow diagram of a procedure according to an embodiment of the present invention

FIG. 6 is a schematic diagram illustrating operations of the mapping control circuit of the backlight data mapping circuit according to an embodiment of the present invention.

FIG. 7 is a schematic diagram illustrating operations of the mapping control circuit of the backlight data mapping circuit according to an alternative embodiment of the present invention.

FIG. 8 is a schematic diagram illustrating operations of the arrangement circuit of the backlight data mapping circuit according to an embodiment of the present invention.

### DETAILED DESCRIPTION

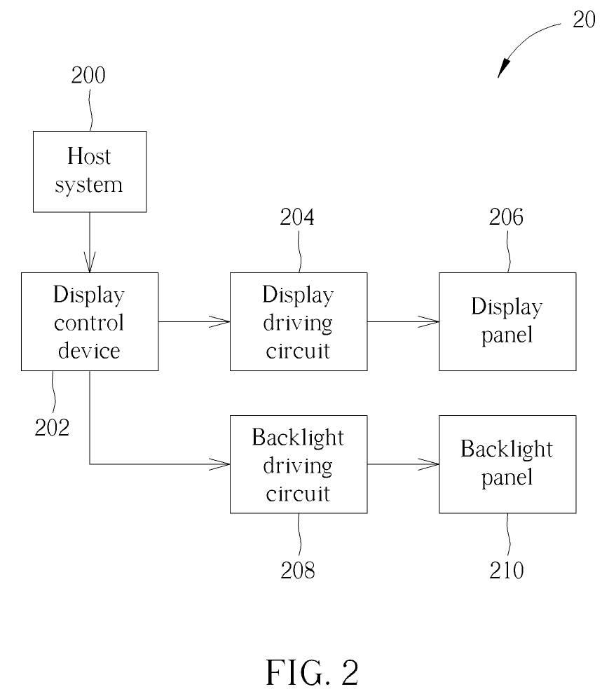

Please refer to FIG. 2, which is a schematic diagram of a display system 20 according to an embodiment of the present invention. The display system 20 includes a host system 200, a display control device 202, a display driving circuit 204, a display panel 206, a backlight driving circuit 208 and a backlight panel 210. The host system 200 may generate or output image data to the display control device 202. The host system 200 may be a system on chip (SoC), but not limited thereto. For example, the host system 200 may be an electronic control unit (ECU) which is a core computer device in a vehicle, but not limited thereto. The display control device 202 may be a device that can generate and provides backlight control data with local dimming control to the backlight driving circuit 208. The display control device 202 may also generate display-related timing control signals. The display control device 202 may be a timing controller (TCON) IC, a bridge IC, or a bridge and TCON integrated IC. The display control device 202 and the display driving circuit 204 may be separate semiconductor chips.

The display driving circuit 204 may generate display-related driving signals to drive pixels of the display panel 206 for display purpose. According to design requirements, the display driving circuit 204 may include a source driving circuit, a source driver, a gate driver, a gate on array (GOA) circuit, a touch sensing control circuit, a fingerprint sensing control circuit, and/or other similar circuit that is capable of driving or controlling the display panel 206, or combination thereof. The display panel 206 may display the image data controlled by the display driving circuit 204. The display panel 206 may be a liquid crystal display (LCD) panel or any other type of display panel which needs backlight.

Moreover, the backlight driving circuit 208 includes a plurality of LED drivers (backlight drivers). The LED drivers may be implemented as integrated circuits (ICs). The backlight panel 210 includes a plurality of backlight zones. Each backlight zone includes a plurality of light-emitting diode (LEDs). The backlight zones may correspond to the overall display area of the display panel 206. By the display control device 202 which generates backlight control data with local dimming control to the LED drivers of the backlight driving circuit 208, the LED drivers of the backlight driving circuit 208 can generate driving currents for driving the backlight zones of the backlight panel 210, such that the backlight panel 210 provides the backlight source for the display panel 206. In the description of the present disclosure, the backlight control data is also called backlight data in short.

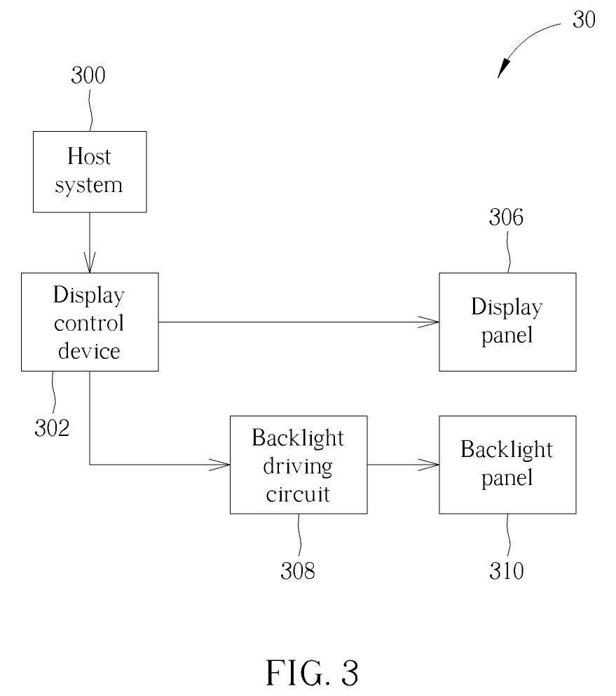

Please refer to FIG. 3, which is a schematic diagram of a display system 30 according to an embodiment of the present invention. The display system 30 includes a host system 300, a display control device 302, a display panel 306, a backlight driving circuit 308 and a backlight panel 310. Please note that the host system 300, the display panel 306, the backlight driving circuit 308 and the backlight panel 310 are referred to the similar devices in the display system 20 of FIG. 2, and further description is omitted for brevity. Different from the display control device 202, the display control device 302 may be a device that does not only provide backlight control data with local dimming control to the backlight driving circuit 308 but also provides display-related driving signals to drive the display panel 306. For example, the display control device 302 may be a TCON embedded driver (TED) or an automotive touch and display driver integrated circuit.

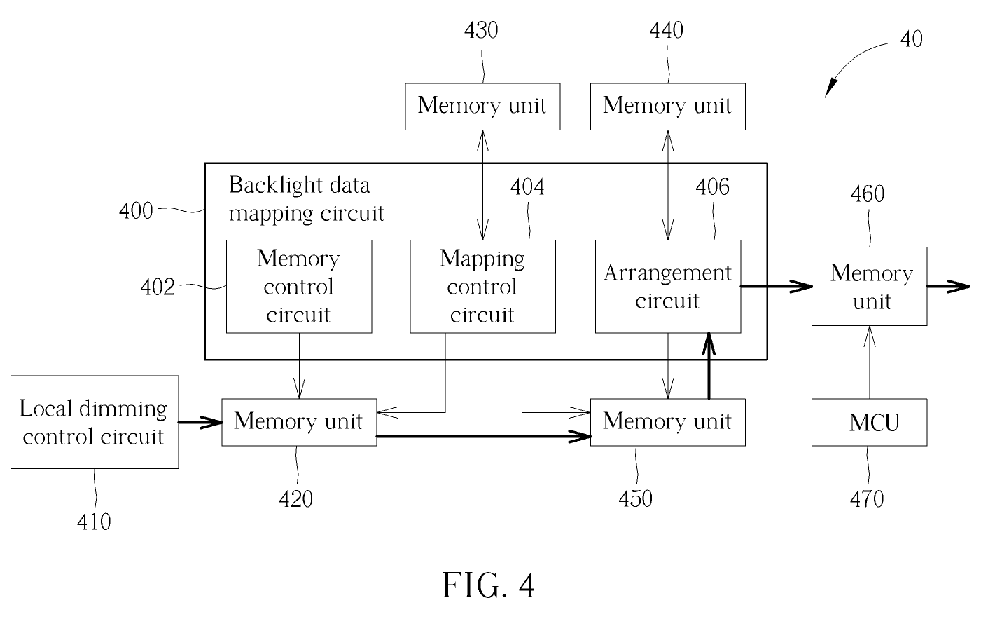

The display control device 202 in the display system 20, or the display control device 302 in the display system 30, may be implemented to include features of a display control device 40, which is illustrated in FIG. 4. FIG. 4 is a schematic diagram of the display control device 40 according to an embodiment of the present invention. The display control device 40 includes a backlight data mapping circuit 400, a local dimming control circuit 410, memory units 420, 430, 440, 450 and 460, and a microcontroller unit (MCU) 470. The local dimming control circuit 410 can generate backlight data corresponding to the plurality of backlight zones of the backlight panel 210. The memory units 420, 430, 440, 450 and 460 may be static random access memories (SRAMs). The MCU 470 may include firmware, and the firmware of MCU 470 may control the MCU 470 to read out data and write the data to a configured memory unit. The backlight data mapping circuit 400 can read backlight data from the memory units, process backlight data from the memory units, and write backlight data to the memory units. In the following descriptions, the exemplary backlight data represent duty cycles of PWM signals that determine the driving currents of the backlight zones. In another embodiments, the backlight data may represent (and may not be limited to) pulse widths of active parts of PWM signals that determine the driving currents of the backlight zones, or the amount of the driving currents of the backlight zones. The local dimming control circuit 410, the memory units 420, 430, 440, 450 and 460, and the MCU 470 with firmware in FIG. 4 may be disposed in the same IC as where the backlight data mapping circuit 400 is disposed.

The backlight data mapping circuit 400 includes a memory control circuit 402, a mapping control circuit 404 and an arrangement circuit 406. The backlight data mapping circuit 400 can receive duty cycle information of PWM signals (as the backlight data) corresponding to the backlight zones and process the duty cycle information to generate rearranged duty cycle information corresponding to the plurality of backlight zones. The memory control circuit 402 is configured to sequentially write original duty cycle information corresponding to the backlight zones of the backlight panel 210 into the memory unit 420. The mapping control circuit 404 is configured to convert the original duty cycle information into mapped duty cycle information according to a remapping table. The arrangement circuit 406 is configured to convert the mapped duty cycle information into rearranged duty cycle information matching a backlight driver output format according to backlight-zone-to-driver-output mapping information. The rearranged duty cycle information can be transmitted to the LED drivers of the backlight driving circuit 208 for generating backlight driving currents.

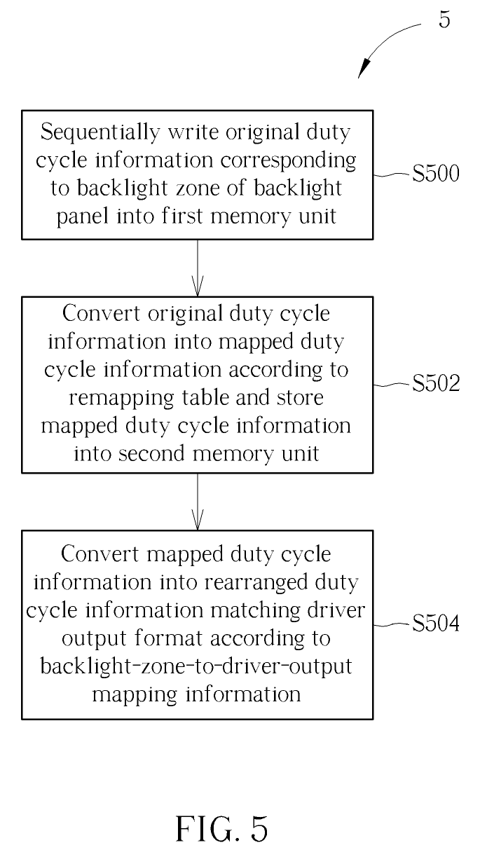

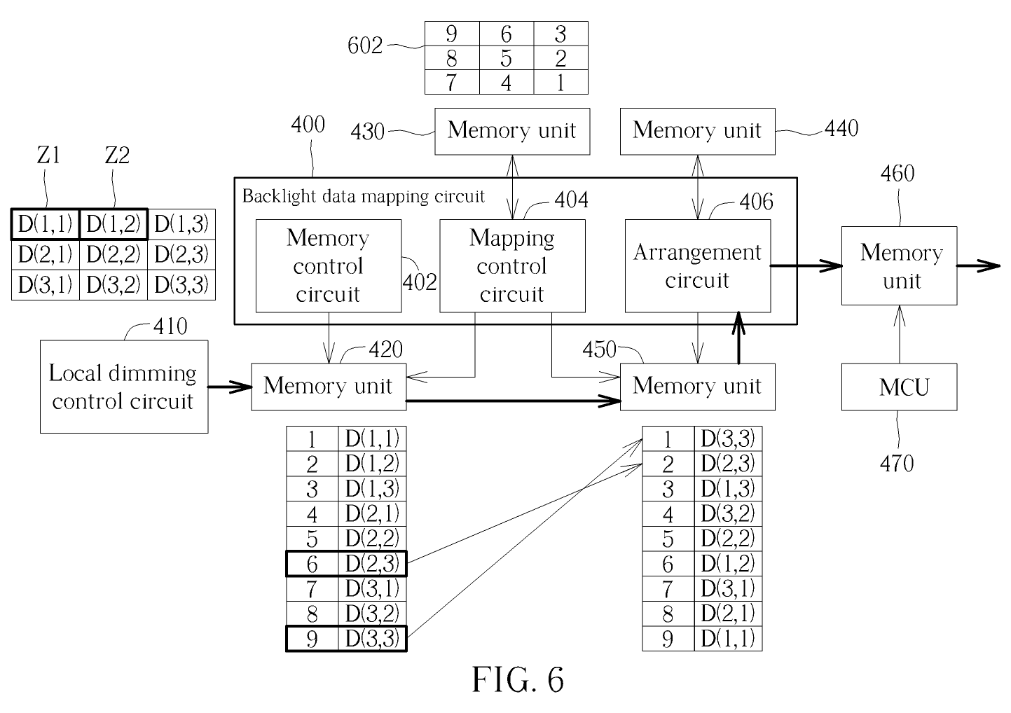

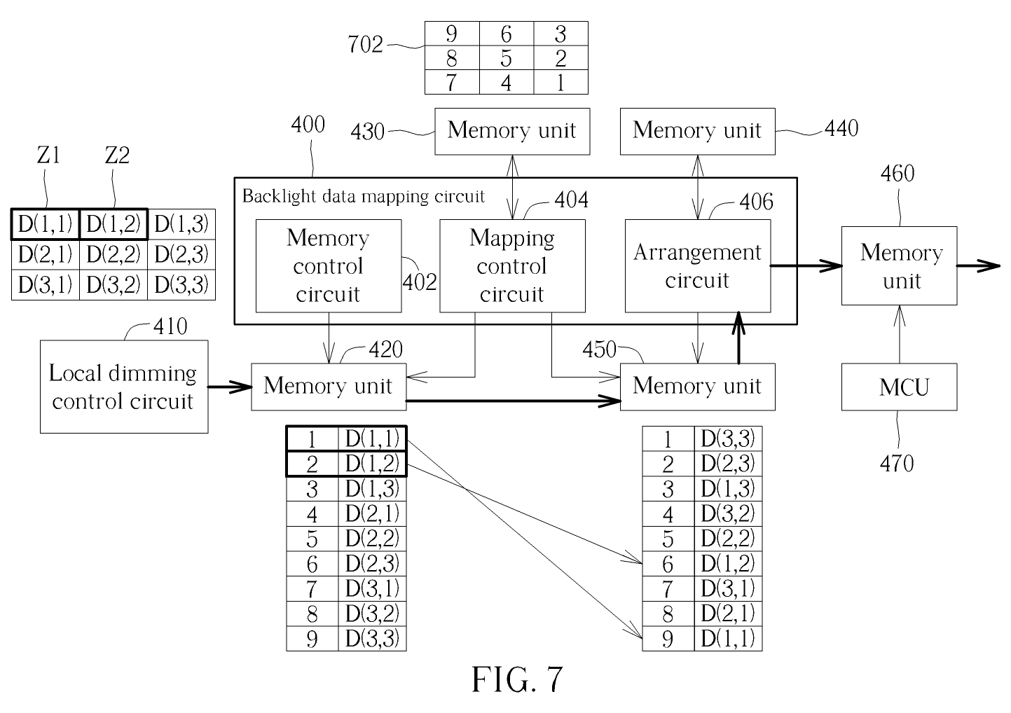

For an illustration of the operations of the backlight data mapping circuit 400, please refer to FIG. 5, FIG. 6 and FIG. 7. FIG. 5 is a flow diagram of a procedure 5 according to an embodiment of the present invention. FIG. 6 and FIG. 7 are schematic diagrams illustrating operations of the backlight data mapping circuit 400 according to an embodiment of the present invention. For example, as shown in the left portion of FIG. 6, there are nine backlight zones The original duty cycle information D(1,1) to D(3,3) corresponding to the backlight zones Z1, Z2… Z9 are generated by the local dimming control circuit 410. For example, a duty cycle information corresponding to one backlight zone is N-bits data, representing the actual duty cycle (%) of a PWM signal corresponding to the backlight zone. Duty cycle information D(1,1) is corresponding to the backlight zone Z1, duty cycle information D(1,2) is corresponding to the backlight zone Z2, and so on. The local dimming control circuit 410 sends the duty cycle information (regarded as original backlight data) to the memory unit 420.

In Step S500, the memory control circuit 402 may sequentially write original duty cycle information corresponding to the backlight zones of the backlight panel 210 into the memory unit 420. The memory control circuit 402 controls locations (addresses) in the memory unit 420 where the duty cycle information D(1,1) to D(3,3) are written. As such, the duty cycle information D(1,1) to D(3,3) may be sequentially written into the memory unit 420. As shown in the bottom of FIG. 6, the duty cycle information D(1,1) of the backlight zone Z1 is written into the 1^{s}^{t} location in the memory unit 420, the duty cycle information D(1,2) of the backlight zone Z2 is written into the 2^{nd} location in the memory unit 420, the duty cycle information D(1,3) of the backlight zone Z3 is written into the 3^{th} location in the memory unit 420, the duty cycle information D(2,1) of the backlight zone Z4 is written into the 4^{th} location in the memory unit 420, the duty cycle information D(2,2) of the backlight zone Z5 is written into the 5^{th} location in the memory unit 420, and the like. After all of duty cycle information corresponding to one image frame is fully transmitted, the local dimming control circuit 410 may transmit a transmission end indication signal to the memory control unit 402.

In Step S502, the mapping control circuit 404 may convert the original duty cycle information into mapped duty cycle information (or called mapped backlight data) according to a remapping table 602 in FIG. 6 and store the mapped duty cycle information into the memory unit 450. The remapping table 602 is prestored in a non-volatile memory (e.g., flash memory, and it’s not shown in the figures) before the backlight data mapping circuit 400 of the display control device 40 is power on. The remapping table 602 is loaded into the memory unit 430 (e.g., SRAM) from the non-volatile memory after the backlight data mapping circuit 400 is power on. The remapping table 602 includes a plurality of location index numbers that indicate respective locations of the memory unit 420 or the memory unit 450. Each location index number indicates a location of the memory unit 420, or a location of the memory unit 450 instead. According to the location index numbers, the mapping control circuit 404 is able to map each original duty cycle information stored in the memory unit 420 into a designated location in the memory unit 450, which may not be in the same location as in the memory unit 420.

In one embedment of using the remapping table as shown FIG. 6, each location index number of the remapping table 602 indicates a location of the memory unit 420. The mapping control circuit 404 sequentially reads each location index number of the remapping table 602 that indicates a location of the memory unit 420 and reads duty cycle information (i.e., original duty cycle information) corresponding to the location index number from the memory unit 420, and sequentially writes the duty cycle information to the memory unit 450 (i.e., from the first location of the memory unit 450 to the last location of the memory unit 450). The duty cycle information stored in the memory unit 450 is taken as mapped duty cycle information. For example, as shown in FIG. 6, the first location index number that the mapping control circuit 404 reads from the remapping table 602 is 9, and the firstly read location index number, 9, represents the 9^{th} location of the memory unit 420. The mapping control circuit 404 reads the duty cycle information D(3,3) stored in the 9^{th} location of the memory unit 420 based on the firstly read location index number (i.e., 9), and writes the duty cycle information D(3,3) into the first location of the memory unit 450. Moreover, the second location index number that the mapping control circuit 404 reads from the remapping table 602 is 6, and the secondly read location index number, 6, represents the 6^{th} location of the memory unit 420. The mapping control circuit 404 reads the duty cycle information D(2,3) stored in the 6^{th} location of the memory unit 420 according to the secondly read location index number (i.e., 6), and writes the duty cycle information D(2,3) into the second location of the memory unit 450. .

In another embedment of using the remapping table as shown FIG. 7, each location index number of the remapping table 702 indicates a location of the memory unit 450. The mapping control circuit 404 sequentially reads each duty cycle information (i.e., original duty cycle information) from the first location of the memory unit 420 to the last location of the memory unit 420, and writes each read duty cycle information to a corresponding location of the memory unit 450 indicated by the location index of the remapping table 702. For example, the firstly read duty cycle information is the duty cycle information D(1,1) stored in the 1^{th} location of the memory unit 420, and the duty cycle information D(1,1) is firstly written into the 9^{th} location of the memory unit 450 that is indicated by the first location index number, 9, of the remapping table 702; the secondly read duty cycle information is the duty cycle information D(1,2) stored in the 2^{th} location of the memory unit 420, and the duty cycle information D(1,2) is secondly written into the 6^{th} location of the memory unit 450 that is indicated by the second location index number, 6, of the remapping table 702; the thirdly read duty cycle information is the duty cycle information D(1,3) stored in the 3^{th} location of the memory unit 420, and the duty cycle information D(1,3) is thirdly written into the 3^{th} location of the memory unit 450 that is indicated by the third location index number, 3, of the remapping table 702, and so on. Therefore, the original duty cycle information can be remapped to the actual locations of the backlight zones by using the remapping table 702.

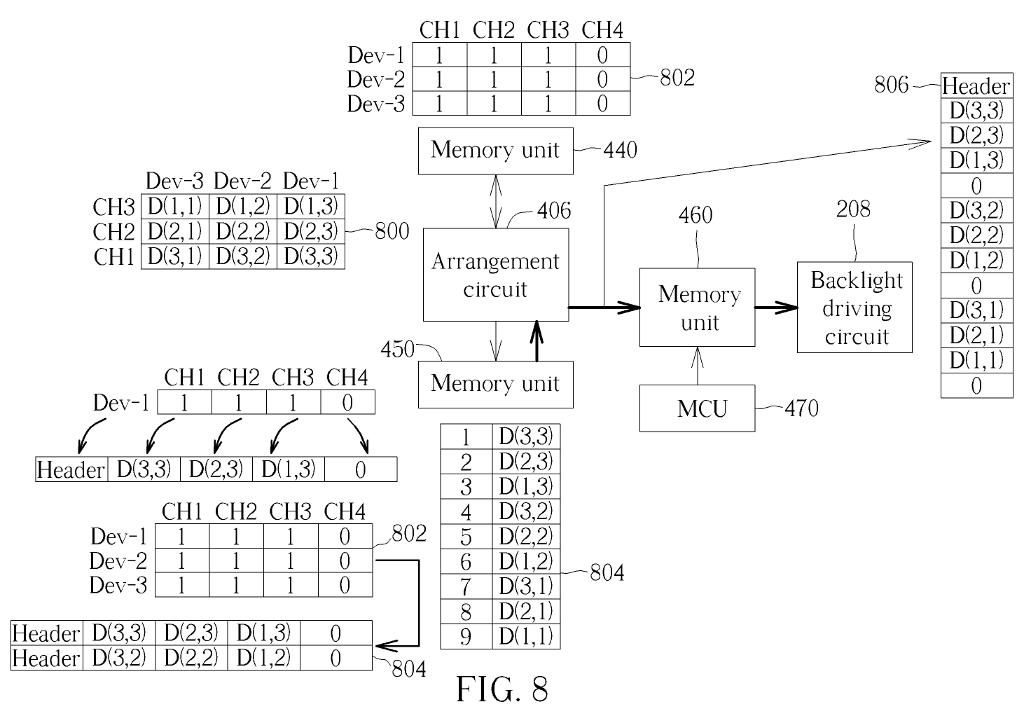

In Step S504, the arrangement circuit 406 converts the mapped duty cycle information into rearranged duty cycle information matching a backlight driver output format according to backlight-zone-to-driver-output mapping information that defines a plurality of status values. Each status value is with respect to each driving channel of a plurality of LED driver who drive the backlight zones of the backlight panel 210. The backlight-zone-to-driver-output mapping information is corresponding to the physical layout of the LED drivers of the backlight driving circuit 208. For example, as shown in the left portion of FIG. 8, a physical layout diagram 800 represents the physical layout of driving channels of the LED drivers and the backlight zones they drive. Each backlight zone may be driven by a specific output channel (e.g., CHN, where N is the sequence number of the output channel) of a specific LED driver (e.g., Dev-M, where M is the sequence number of the LED driver) by employing corresponding duty cycle information D(x,y). For example, backlight zone Z1 is driven by the third output channel CH3 of the LED driver Dev-3. Therefore, the third output channel CH3 of the LED driver Dev-3 outputs the driving current generated according to the duty cycle information D(1,1).

The backlight zone-to-driver output mapping information is prestored in a non-volatile memory (e.g., flash memory, not shown in the FIG. 4) before the backlight data mapping circuit 400 is power on, and backlight zone-to-driver output mapping information is loaded into to memory unit 440 from the non-volatile memory after the backlight data mapping circuit 400 is power on. As the example shown in FIG. 8, backlight zone-to-driver output mapping information 802 includes dimming control status value (1/0) with respect to each driving channel (e.g. one of CH1-CH4) of each LED driver (e.g. one of Dev-1 to Dev-3). The dimming control status value “1" indicates that driving channel follows the control information (i.e., duty cycle information) stored in the memory unit 450 and the status value “0" indicates that driving channel follows a preconfigured control information which is not stored in the memory unit 450. In the example shown in bottom part of FIG. 8, the driving channels CH1-Ch3 of each of the LED drivers Dev-1 to Dev-3 follows the duty cycle information stored in the memory unit 450 and the driving channel CH4 of each of the LED drivers Dev-1 to Dev-3 is given preconfigured control information such as a duty cycle 0%. For example, the dimming control status value for driving channel CH1 of LED driver Dev-1 is “1", and the mapped duty cycle information with respect to the driving channel CH1 of LED driver Dev-1 can be duty cycle information D(3,3) stored in the memory unit 450. The dimming control status value for driving channel CH4 of LED driver Dev-1 is “0", and the mapped duty cycle information with respect to the driving channel CH4 of LED driver Dev-1 can be duty cycle 0%, and the like.

As shown in FIG. 8, the arrangement circuit 406 may covert the mapped duty cycle information 804 in series D(3,3), D(2,3), D(1,3), D(3,2), D(2,2), D(1,2), D(3,1), D(2,1), and D(1,1) according to the backlight zone-to-driver output mapping information, into rearranged duty cycle information 806, which are D(3,3), D(2,3), D(1,3), 0, D(3,2), D(2,2), D(1,2), 0, D(3,1), D(2,1), D(1,1), 0 in series, and the arrangement circuit 406 transmits the mapped duty cycle information with header with respect to respective LED drivers Dev-1 to Dev-3 to the memory unit 460 which can be accessed by the MCU 470 with firmware of local dimming control.

The MCU 470 controls the rearranged duty cycle information stored in the memory unit 460 to be transmitted to at least one backlight driver of the backlight driving circuit 208. For example, the MCU 470 accesses the rearranged duty cycle information with header stored in the memory unit 460, and controls the rearranged duty cycle information to be transmitted to the LED drivers by the following order:

Dev1-CH1[D(3,3)] --> Dev1-CH2[D(2,3)] --> Dev1-CH3[D(1,3)] -->

Dev1-CH4[0] --> Dev2-CH1[D(3,2)] --> Dev2-CH2[D(2,2)] -->

Dev2-CH3[D(1,2)] --> Dev2-CH4[0] --> Dev3-CH1[D(3,1)] -->

Dev3-CH2[D(2,1)] --> Dev3-CH3[D(1,1)] --> Dev3-CH4[0]

Therefore, the LED drivers of the backlight driving circuit 208 can generate driving currents to drive the corresponding backlight zones of backlight panel 210 according to the rearranged duty cycle information for performing local dimming, such that the backlight panel 210 provides the uniform backlight source for the display panel 206.

In addition, the relationship between the LED driver channels of the LED drivers in the backlight driving circuit and the backlight zones of the backlight panel can be arranged arbitrarily. The backlight data mapping circuit 400 of the embodiments of the present invention can be applied for driving rectangular backlight panel or free form backlight panel. The embodiments of the present invention can be applied in any kind of display device with local dimming function, such as vehicle screen, mobile phone, and notebook.

To sum up, the embodiments of the present invention may provide the backlight data mapping circuit and the display control device for fast mapping backlight data such that the mapped backlight data are in a proper arrangement corresponding to the real layout of backlight zones of the backlight panel. Accordingly, the backlight driver can generate driving currents for driving the backlight zones of the backlight panel.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A backlight data mapping circuit, comprising:
a memory control circuit, configured to sequentially write original duty cycle information corresponding to a plurality of backlight zones of a backlight panel into a first memory unit;
a mapping control circuit, configured to convert the original duty cycle information into mapped duty cycle information according to a remapping table and store the mapped duty cycle information into a second memory unit, wherein the remapping table comprises a plurality of location index numbers that indicate respective locations of the first memory unit or the second memory unit; and
an arrangement circuit, configured to convert the mapped duty cycle information into rearranged duty cycle information matching a backlight driver output format according to backlight-zone-to-driver-output mapping information that defines a plurality of status values, each status value being with respect to each driving channel of a plurality of LED driver who drive the backlight zones of the backlight panel.

2. The backlight data mapping circuit of claim 1, wherein the mapping control circuit converting the original duty cycle information corresponding to the plurality of backlight zones into the mapped duty cycle information according to the remapping table comprises:
reading the original duty cycle information from the first memory unit according to the location index numbers of the remapping table and sequentially writing the original duty cycle information into the second memory unit, wherein the remapping table comprises the location index numbers indicating respective locations of the first memory unit and the duty cycle information written into the second memory unit are taken as the mapped duty cycle information.

3. The backlight data mapping circuit of claim 1, wherein the mapping control circuit converting the original duty cycle information corresponding to the plurality of backlight zones into the mapped duty cycle information according to the remapping table comprises:
sequentially reading the original duty cycle information from the first memory unit and writing the original duty cycle information into the second memory unit according to the location index numbers of the remapping table, wherein the remapping table comprises the location index numbers indicating respective locations of the second memory unit and the duty cycle information written into the second memory unit are taken as the mapped duty cycle information.

4. The backlight data mapping circuit of claim 1, wherein the rearranged duty cycle information comprises headers with respect to a plurality of backlight drivers.

5. The backlight data mapping circuit of claim 1, wherein the first memory unit and the second memory unit are SRAM.

6. The backlight data mapping circuit of claim 1, wherein the remapping table and the backlight-zone-to-driver-output mapping information are loaded to SRAM from a non-volatile memory when the backlight data mapping circuit is powered on.

7. A display control device for driving a backlight panel, the backlight panel comprising a plurality of backlight zones, the display control device comprising:
a first memory unit;
a second memory unit;
a local dimming control circuit, configured to generate original duty cycle information corresponding to the plurality of backlight zones;
a backlight data mapping circuit, configured to receive the original duty cycle information corresponding to the plurality of backlight zones and generate rearranged duty cycle information corresponding to the plurality of backlight zones;
a third memory unit, configured to store the rearranged duty cycle information; and
a microcontroller unit, configured to control the rearranged duty cycle information stored in the third memory unit to be transmitted to at least one backlight driver.

8. The display control device of claim 7, wherein the mapping control circuit comprising:
a memory control circuit, configured to sequentially write original duty cycle information corresponding to a plurality of backlight zones of a backlight panel into a first memory unit;
a mapping control circuit, configured to convert the original duty cycle information into mapped duty cycle information according to a remapping table and store the mapped duty cycle information into a second memory unit, wherein the remapping table comprises a plurality of location index numbers that indicate respective locations of the first memory unit or the second memory unit; and
an arrangement circuit, configured to convert the mapped duty cycle information into rearranged duty cycle information matching a backlight driver output format according to backlight-zone-to-driver-output mapping information that defines a plurality of status values, each status value being with respect to each driving channel of a plurality of LED driver who drive the backlight zones of the backlight panel.

9. The display control device of claim 8, wherein the mapping control circuit converting the original duty cycle information corresponding to the plurality of backlight zones into the mapped duty cycle information according to the remapping table comprises:
reading the original duty cycle information from the first memory unit according to the location index numbers of the remapping table and sequentially writing the original duty cycle information into the second memory unit, wherein the remapping table comprises the location index numbers indicating respective locations of the first memory unit and the duty cycle information written into the second memory unit are taken as the mapped duty cycle information.

10. The display control device of claim 8, wherein the mapping control circuit converting the original duty cycle information corresponding to the plurality of backlight zones into the mapped duty cycle information according to the remapping table comprises:
sequentially reading the original duty cycle information from the first memory unit and writing the original duty cycle information into the second memory unit according to the location index numbers of the remapping table, wherein the remapping table comprises the location index numbers indicating respective locations of the second memory unit and the duty cycle information written into the second memory unit are taken as the mapped duty cycle information.

11. The display control device of claim 7, wherein the rearranged duty cycle information comprises headers with respect to a plurality of backlight drivers.

12. The display control device of claim 7, wherein the first memory unit, the second memory unit and the third memory unit are SRAM.

13. The display control device of claim 7, wherein the remapping table and the backlight-zone-to-driver-output mapping information are loaded to SRAM from a non-volatile memory when the backlight data mapping circuit is powered on.

14. A backlight control data mapping method, comprising:
sequentially writing original duty cycle information corresponding to a plurality of backlight zone of a backlight panel into a first memory unit;
converting the original duty cycle information into mapped duty cycle information according to a remapping table and storing the mapped duty cycle information into a second memory unit, wherein the remapping table comprises a plurality of location index numbers that indicate respective locations of the first memory unit or the second memory unit; and
converting the mapped duty cycle information into rearranged duty cycle information matching a driver output format according to backlight-zone-to-driver-output mapping information that defines a plurality of status values, each status value being with respect to each driving channel of a plurality of LED driver who drive the backlight zones of the backlight panel.

15. The backlight control data mapping method of claim 14, further comprising:
reading the original duty cycle information from the first memory unit according to the location index numbers of the remapping table; and
sequentially writing the original duty cycle information into the second memory unit, wherein the remapping table comprises the location index numbers indicating respective locations of the first memory unit and the duty cycle information written into the second memory unit are taken as the mapped duty cycle information.

16. The backlight control data mapping method of claim 14, further comprising:
sequentially reading the original duty cycle information from the first memory unit; and
writing the original duty cycle information into the second memory unit according to the location index numbers of the remapping table, wherein the remapping table comprises the location index numbers indicating respective locations of the second memory unit and the duty cycle information written into the second memory unit are taken as the mapped duty cycle information.

17. The backlight control data mapping method of claim 14, wherein the rearranged duty cycle information comprises headers with respect to a plurality of backlight drivers.

18. The backlight data mapping circuit of claim 1, further comprising:
loading the remapping table and the backlight-zone-to-driver-output mapping information to SRAM from a non-volatile memory when a backlight data mapping circuit processing the original duty cycle information and the mapped duty cycle information is powered on.
